(19) United States
(12) Patent Application Publication
(10) Pub. No.: US 2006/0290652 A1
(43) Pub. Date: Dec. 28, 2006

(54) Driving scheme for monochrome mode and transition method for monochrome-to-greyscale mode in bi-stable displays

(76) Inventors: Guofu Zhou, Best (NL); Jan van de Kamer, Heerlen (NL); Mark T. Johnson, Veldhoven (NL); Neculai Ailenei, Landgraaf (NL)

Correspondence Address: PHILIPS INTELLECTUAL PROPERTY & STANDARDS, P.O. BOX 3001, BRIARCLIFF MANOR, NY, 10510, US

(21) Appl. No.: 10/573,548

(22) PCT Filed: Sep. 24, 2004
(86) PCT No.: PCT/IB04/51856

§ 371 Date: Mar. 27, 2006

Related U.S. Application Data
(60) Provisional application No. 60/506,888, filed on Sep. 29, 2003.

(51) Int. Cl. G09G 3/34

(52) U.S. Cl. 345/107

(57) ABSTRACT

Image quality is improved when updating a display image (310) in a bi-stable electronic reading device (300, 400) such as one using an electrophoretic display, by providing both monochrome and greyscale images. When an update mode of a pixel (2) of the display changes from a monochrome to greyscale, a compensating pulse (805, 825, 845, 865) is applied. The compensating pulse represents an energy based on the energy difference between: (a) an over-reset pulse (815, 835, 855, 875) used during the greyscale update mode and (b) a standard reset pulse (610, 660) used during the monochrome update mode. Also, a monochrome update waveform (600, 650) includes a standard reset pulse (610, 660) whose duration is substantially less than a duration of an over-reset pulse (815, 835, 855, 875) used in a greyscale update waveform (800, 820, 840 and 860). The monochrome update mode is used in combination with the greyscale update mode when possible.

The invention relates generally to electronic reading devices such as electronic books and electronic newspapers and, more particularly, to a method and apparatus for updating images with improved image quality and reduced update time using both monochrome and greyscale images.

Recent technological advances have provided “user friendly” electronic reading devices such as e-books that open up many opportunities. For example, electrophoretic displays hold much promise. Such displays have an intrinsic memory behavior and are able to hold an image for a relatively long time without power consumption. Power is consumed only when the display needs to be refreshed or updated with new information. So, the power consumption in such displays is very low, suitable for applications for portable e-reading devices like e-books and e-newspaper. Electrophoresis refers to movement of charged particles in an applied electric field. When electrophoresis occurs in a liquid, the particles move with a velocity determined primarily by the viscous drag experienced by the particles, their charge (either permanent or induced), the dielectric properties of the liquid, and the magnitude of the applied field. An electrophoretic display is a type of bi-stable display, which is a display that substantially holds an image without consuming power after an image update.

For example, international patent application WO 99/53373, published Apr. 9, 1999, by E Ink Corporation, Cambridge, Mass., US, and entitled Full Color Reflective Display With Multichromatic Sub-Pixels, describes such a display device. WO 99/53373 discusses an electronic ink display having two substrates. One is transparent, and the other is provided with electrodes arranged in rows and columns. A display element or pixel is associated with an intersection of a row electrode and column electrode. The display element is coupled to the column electrode using a thin film transistor (TFT), the gate of which is coupled to the row electrode. This arrangement of display elements, TFT transistors, and row and column electrodes together forms an active matrix. Furthermore, the display element comprises a pixel electrode. A row driver selects a row of display elements, and a column or source driver supplies a data signal to the selected row of display elements via the column electrodes and the TFT transistors. The data signals correspond to graphic data to be displayed, such as text or figures.

The electronic ink is provided between the pixel electrode and a common electrode on the transparent substrate. The electronic ink comprises multiple microcapsules of about 10 to 50 microns in diameter. In one approach, each microcapsule has positively charged white particles and negatively charged black particles suspended in a liquid carrier medium or fluid. When a positive voltage is applied to the pixel electrode, the white particles move to a side of the microcapsule directed to the transparent substrate and a viewer will see a white display element. At the same time, the black particles move to the pixel electrode at the opposite side of the microcapsule where they are hidden from the viewer. By applying a negative voltage to the pixel electrode, the black particles move to the common electrode at the side of the microcapsule directed to the transparent substrate and the display element appears dark to the viewer. At the same time, the white particles move to the pixel electrode at the opposite side of the microcapsule where they are hidden from the viewer. When the voltage is removed, the display device remains in the acquired state and thus exhibits a bi-stable character. In another approach, particles are provided in a dyed liquid. For example, black particles may be provided in a white liquid, or white particles may be provided in a black liquid. Or, other colored particles may be provided in different colored liquids, e.g., white particles in green liquid.

Other fluids such as air may also be used in the medium in which the charged black and white particles move around in an electric field (see, e.g., Bridgestone SID2003—Symposium on Information Displays. May 18-23, 2003,—digest 20.3). Colored particles may also be used.

To form an electronic display, the electronic ink may be printed onto a sheet of plastic film that is laminated to a layer of circuitry. The circuitry forms a pattern of pixels that can then be controlled by a display driver. Since the microcapsules are suspended in a liquid carrier medium, they can be printed using existing screen-printing processes onto virtually any surface, including glass, plastic, fabric and even paper. Moreover, the use of flexible sheets allows the design of electronic reading devices that approximate the appearance of a conventional book.

However, further advancements are needed to improve image quality and reduce image update time.

The present invention addresses the above and other issues. In accordance with the invention, both monochrome and greyscale update modes are provided in a bi-stable display such as an active matrix electrophoretic display. One advantage of the invention is that the total image update time (IUT) during the monochrome update mode is reduced, e.g., to about half that of the greyscale update mode. A technique is further proposed for avoiding additional dc voltage on the pixel that is induced by the mode change by compensating for the pulse energy difference between the monochrome and greyscale update modes, when the display mode is changed from monochrome to greyscale. In this case, prior to the application of the greyscale update waveform, a compensating voltage pulse is applied having a pulse energy equal to the reset pulse-energy difference between the greyscale waveform and the monochrome waveform. Moreover, the compensating pulse has the same voltage sign or polarity as the voltage pulse used in the previous monochrome-to-monochrome image transition. In other words, the compensating pulse has the same polarity as that used in the standard reset pulse, which is also the drive pulse, during the monochrome update mode. The pulse-energy is the product of voltage-level×pulse-time. When multiple voltage levels are used, the total energy is the sum of the energy involved in each level of the pulse. One approach may use the same (maximum) amplitude so the pulse time is varied in different drive waveforms. For simplicity, in the discussions below, the pulses with the same amplitude are considered. In this case, the variation of the energy of a pulse directly is proportional to a variation of a pulse time length. However, the examples given below can be generalized to the case where pulses with different amplitudes are used.

In a particular aspect of the invention, a method for updating images on a bi-stable display includes determining when an update mode of the bi-stable display changes from a monochrome update mode to a greyscale update mode. When the update mode changes as indicated in the determining step, a compensating pulse is applied to the bi-stable display. The compensating pulse represents an energy based on an energy difference between: (a) an over-reset pulse used during the greyscale update mode and (b) a standard reset pulse used during the monochrome update mode.

In a further aspect of the invention, a method for updating images on an electronic reading device includes applying a greyscale update waveform to the bi-stable display during a greyscale update mode, and applying a monochrome update waveform to the bi-stable display during a monochrome update mode. The monochrome update waveform includes a standard reset pulse and the greyscale update waveform includes an over-reset pulse.

Related electronic reading devices and program storage devices are also provided.

In the drawings:

FIG. 1 shows diagramatically a front view of an embodiment of a portion of a display screen of an electronic reading device;

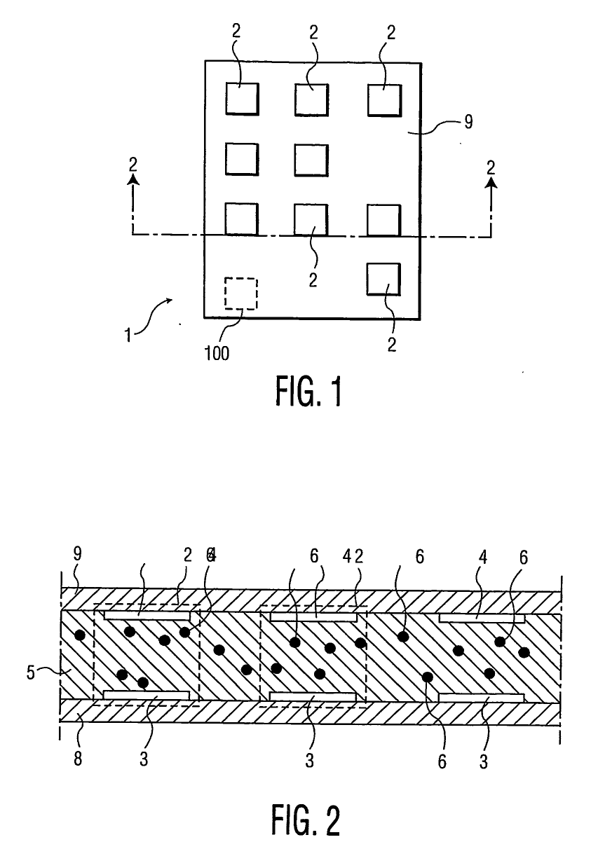

FIG. 2 shows diagramatically a cross-sectional view along 2-2 in FIG. 1;

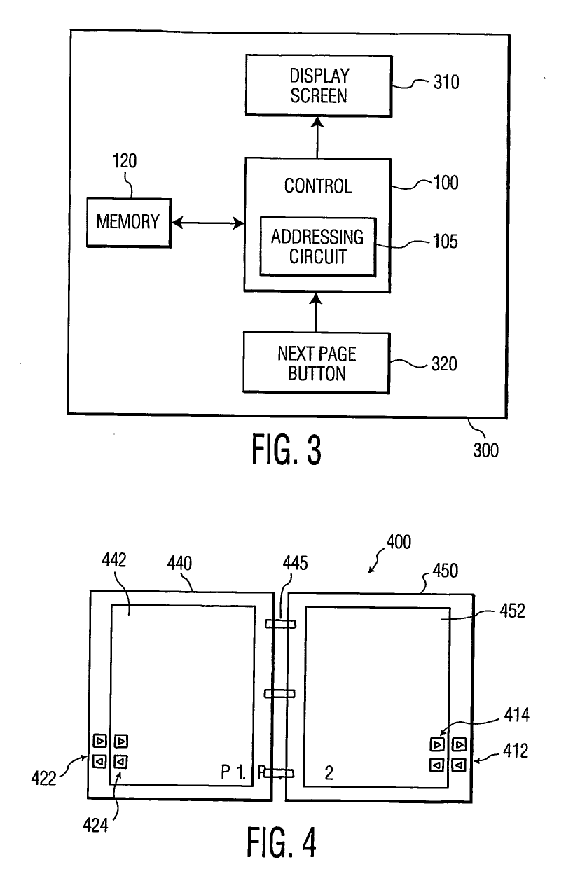

FIG. 3 shows diagramatically an overview of an electronic reading device;

FIG. 4 shows diagramatically two display screens with respective display regions;

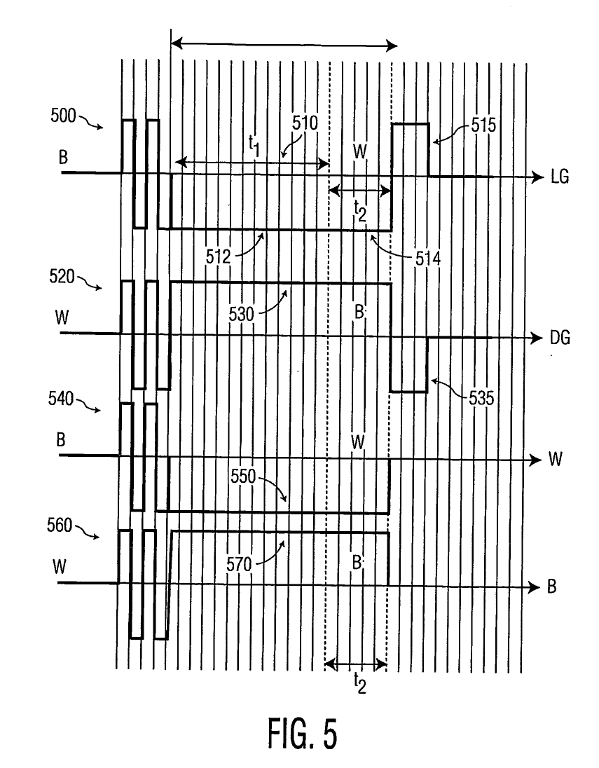

FIG. 5 shows rail-stabilized waveforms for a greyscale update mode;

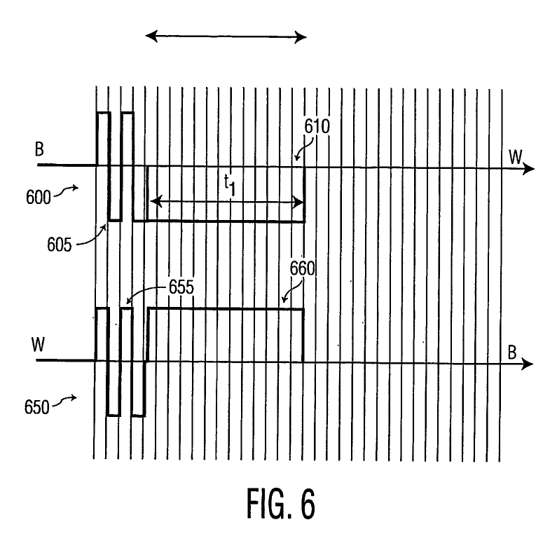

FIG. 6 shows waveforms for a monochrome update mode;

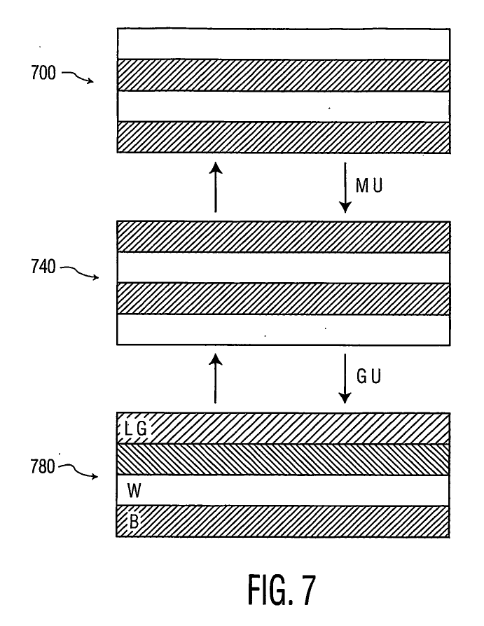

FIG. 7 shows an example of display mode changes; and

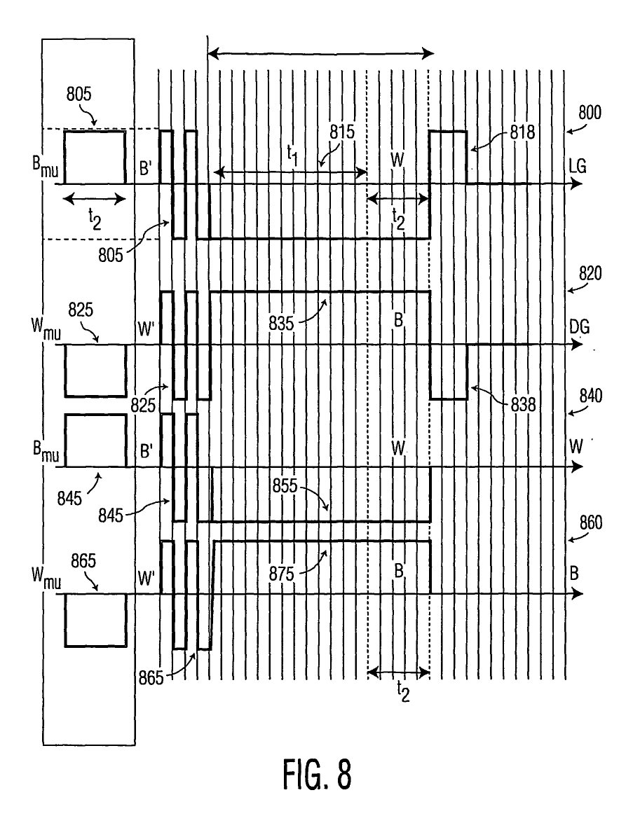

FIG. 8 shows a compensating pulse applied when a display mode is changed from a monochrome update mode to a greyscale update mode.

In all the Figures, corresponding parts are referenced by the same reference numerals.

FIGS. 1 and 2 show the embodiment of a portion of a display panel 1 of an electronic reading device having a first substrate 8, a second opposed substrate 9 and a plurality of picture elements 2. The picture elements 2 may be arranged along substantially straight lines in a two-dimensional structure. The picture elements 2 are shown spaced apart from one another for clarity, but in practice, the picture elements 2 are very close to one another so as to form a continuous image. Moreover, only a portion of a full display screen is shown. Other arrangements of the picture elements are possible, such as a honeycomb arrangement. An electrophoretic medium 5 having charged particles 6 is present between the substrates 8 and 9. A first electrode 3 and second electrode 4 are associated with each picture element 2. The electrodes 3 and 4 are able to receive a potential difference. In FIG. 2, for each picture element 2, the first substrate has a first electrode 3 and the second substrate 9 has a second electrode 4. The charged particles 6 are able to occupy positions near either of the electrodes 3 and 4 or intermediate to them. Each picture element 2 has an appearance determined by the position of the charged particles 6 between the electrodes 3 and 4. Electrophoretic media 5 are known per se, e.g., from U.S. Pat. Nos. 5,961,804, 6,120,839, and 6,130,774 and can be obtained, for instance, from E Ink Corporation.

As an example, the electrophoretic medium 5 may contain negatively charged black particles 6 in a white fluid. When the charged particles 6 are near the first electrode 3 due to a potential difference of, e.g., +15 Volts, the appearance of the picture elements 2 is white. When the charged particles 6 are near the second electrode 4 due to a potential difference of opposite polarity, e.g., −15 Volts, the appearance of the picture elements 2 is black. When the charged particles 6 are between the electrodes 3 and 4, the picture element has an intermediate appearance such as a grey level between black and white. A drive control 100 controls the potential difference of each picture element 2 to create a desired picture, e.g. images and/or text, in a full display screen. The full display screen is made up of numerous picture elements that correspond to pixels in a display.

FIG. 3 shows diagramatically an overview of an electronic reading device. The electronic reading device 300 includes the control 100, including an addressing circuit 105. The control 100 controls the one or more display screens 310, such as electrophoretic screens, to cause desired text or images to be displayed. For example, the control 100 may provide voltage waveforms to the different pixels in the display screen 310. The addressing circuit provides information for addressing specific pixels, such as row and column, to cause the desired image or text to be displayed. As described further below, the control 100 causes successive pages to be displayed starting on different rows and/or columns. The image or text data may be stored in a memory 120. One example is the Philips Electronics small form factor optical (SFFO) disk system. The control 100 may be responsive to a user-activated software or hardware button 320 that initiates a user command such as a next page command or previous page command.

The control 100 may be part of a computer that executes any type of computer code devices, such as software, firmware, micro code or the like, to achieve the functionality described herein. Accordingly, a computer program product comprising such computer code devices may be provided in a manner apparent to those skilled in the art. Moreover, the memory 120 is a program storage device that tangibly embodies a program of instructions executable by a machine such as the control 100 or a computer to perform a method that achieves the functionality described herein. Such a program storage device may be provided in a manner apparent to those skilled in the art.

The control 100 may have logic for periodically providing a forced reset of a display region of an electronic book, e.g., after every x pages are displayed, after every y minutes, e.g., ten minutes, when the electronic reading device is first turned on, and/or when the brightness deviation is larger than a value such as 3% reflection. For automatic resets, an acceptable frequency can be determined empirically based on the lowest frequency that results in acceptable image quality. Also, the reset can be initiated manually by the user via a function button or other interface device, e.g., when the user starts to read the electronic reading device, or when the image quality drops to an unacceptable level.

The invention may be used with any type of electronic reading device. FIG. 4 illustrates one possible example of an electronic reading device 400 having two separate display screens. Specifically, a first display region 442 is provided on a first screen 440, and a second display region 452 is provided on a second screen 450. The screens 440 and 450 may be connected by a binding 445 that allows the screens to be folded flat against each other, or opened up and laid flat on a surface. This arrangement is desirable since it closely replicates the experience of reading a conventional book.

Various user interface devices may be provided to allow the user to initiate page forward, page backward commands and the like. For example, the first region 442 may include on-screen buttons 424 that can be activated using a mouse or other pointing device, a touch activation, PDA pen, or other known technique, to navigate among the pages of the electronic reading device. In addition to page forward and page backward commands, a capability may be provided to scroll up or down in the same page. Hardware buttons 422 may be provided alternatively, or additionally, to allow the user to provide page forward and page backward commands. The second region 452 may also include on-screen buttons 414 and/or hardware buttons 412. Note that the frame 405 around the first and second display regions 442, 452 is not required as the display regions may be frameless. Other interfaces, such as a voice command interface, may be used as well. Note that the buttons 412, 414; 422, 424 are not required for both display regions. That is, a single set of page forward and page backward buttons may be provided. Or, a single button or other device, such as a rocker switch, may be actuated to provide both page forward and page backward commands. A function button or other interface device can also be provided to allow the user to manually initiate a reset.

In other possible designs, an electronic book has a single display screen with a single display region that displays one page at a time. Or, a single display screen may be partitioned into two or more display regions arranged, e.g., horizontally or vertically. In any case, the invention can be used with each display region to reduce image retention effects, induced by the remnant dc on the pixel that is induced by a mode change.

Furthermore, when multiple display regions are used, successive pages can be displayed in any desired order. For example, in FIG. 4, a first page can be displayed on the display region 442, while a second page is displayed on the display region 452. When the user requests to view the next page, a third page may be displayed in the first display region 442 in place of the first page while the second page remains displayed in the second display region 452. Similarly, a fourth page may be displayed in the second display region 452, and so forth. In another approach, when the user requests to view the next page, both display regions are updated so that the third page is displayed in the first display region 442 in place of the first page, and the fourth page is displayed in the second display region 452 in place of the second page. When a single display region is used, a first page may be displayed, then a second page overwrites the first page, and so forth, when the user enters a next page command. The process can work in reverse for page back commands. Moreover, the process is equally applicable to languages in which text is read from right to left, such as Hebrew, as well as to languages such as Chinese in which text is read column-wise rather than row-wise.

Additionally, note that the entire page need not be displayed on the display region. A portion of the page may be displayed and a scrolling capability provided to allow the user to scroll up, down, left or right to read other portions of the page. A magnification and reduction capability may be provided to allow the user to change the size of the text or images. This may be desirable for users with reduced vision, for example.

Discussion of Monochrome and Greyscale Update Modes

It has been recently demonstrated that accurate grey levels in a bi-stable display can be achieved using driving schemes including both a driving voltage pulse and shaking pulses. Shaking pulses are required in order to reduce the dependence of the unpowered image holding time and the image history influence. It has further been demonstrated that accurate grey levels can be achieved using a rail-stabilized driving scheme when the number of voltage levels is limited, for example, to −15V (white), 0 V and +15V (black). This means that the grey levels are always achieved either from a reference black color state or a reference white color state (the two “rails”). Moreover, a driving technique using a single over-reset voltage pulse has been found to be most promising for driving an electrophoretic display. The pulse sequence usually includes three portions: first shaking pulses, a reset pulse and a greyscale driving pulse. This technique is schematically shown in FIG. 5 for representative greyscale image transitions. A two-bit grey scale allows four color states: white, light grey, dark grey, and black. A monochrome scale has only black and white color states.

In FIG. 5, waveforms 500, 520, 540 and 560 respectively indicate a black (B) to light grey (LG) transition, white (W) to dark grey (DG) transition, black (B) to white (W) transition, and white (W) to black (B) transition. A separate waveform is applied to each pixel in the display by the control 100 to display desired text and/or image. The total image update time (is the sum of the time periods used in each portion. Shaking pulses 505, 525, 545, 565 are required for reducing the effect of the unpowered image holding time and image history, thereby reducing the image retention and increasing greyscale accuracy. The reset pulse must be longer than the minimum time required for moving the particles from the present position or color state to an extreme position or color state (e.g., black or white) to ensure that the old image is timely erased during a new image update and image quality is guaranteed. The reset pulse, e.g., 510, has two parts: the “standard” reset 512 (having a duration t₁) and the additional “over-reset” portion 514 (having a duration t₂). The entire over-reset pulse 510 is considered to include the standard reset portion 512 and the over-reset portion 514, for a total duration of t₁+t₂. The standard reset portion 512 requires a duration that is proportional to the distance that the particles need to move between two electrodes in the display. That is, the duration (t₁) should be sufficient to move particles that form the bi-stable display from a black color state to a white color state, or from a white color state to a black color state.

For example, for the waveform 500, a white color state is achieved at the end of the over-reset pulse 510. The subsequent drive pulse 515 moves the particles of the associated pixel in the direction of the black color state until the light grey color state is achieved. For the waveform 520, a black color state is achieved at the end of the over-reset pulse 530, and the subsequent drive pulse 535 moves the particles in the direction of the white color state until the dark grey color state is achieved. For the waveform 540, a white color state is achieved at the end of the over-reset pulse 550, so no subsequent drive pulse is needed. Similarly, for the waveform 560, a black color state is achieved at the end of the over-reset pulse 570, so no subsequent drive pulse is needed.

After the standard reset pulse, the desired optical state change is achieved. The over-reset portion is needed only for improving the image quality, after which there is substantially no visible optical change. The time period t₂ used in the over-reset pulse portion, e.g., 514, is typically on the same order as the standard reset duration t₁. In other words, the duration (t₁+t₂) of the over-reset pulse is approximately twice the duration (to) of the standard reset pulse. Generally, the duration (t₁+t₂) of the over-reset pulse will be substantially greater than the duration (to) of the standard reset pulse. For simplicity, the same over-reset portion duration t₂ is used in all transitions in FIG. 5. A total image update time of 900 ms has been achieved using the waveforms of FIG. 5, which is too long for some applications.

FIG. 6 shows waveforms for a monochrome update mode. The introduction of the monochrome mode in combination with the greyscale mode according to the invention is particularly advantageous for enhancing an e-book based on an electrophoretic display because many book contents are monochrome while some of them are greyscale images. For a display or display region that uses monochrome pixels only, the control can invoke a monochrome update mode. The control transitions to a greyscale update mode when one or more pixels in the display or display regions use greyscale pixels. Thus, a monochrome update mode is used in combination with a greyscale update mode when possible. Appropriate software instructions can be implemented by the control 100 for this purpose to determine which mode should be used, and when there is a mode change.

The waveforms for the monochrome update mode include a waveform 600 for a black to white transition, which includes shaking pulses 605 and a standard reset pulse 610 having a duration t₁. Similarly, a waveform 650 for a white to black transition includes shaking pulses 655 and a standard reset pulse 660 having a duration t₁. The reset/drive pulses 610 and 660 are used for driving a pixel from black to white, or from white to black. Compared to the waveforms of FIG. 5, the difference is that the duration of the reset/drive pulse in the monochrome mode is equal to the standard reset pulse duration in greyscale mode. The total image update time now becomes about half of that needed in the greyscale update mode for the same transitions. This results in quicker page updates to increase the user's convenience.

FIG. 7 shows an example of display mode changes. Four example block images are updated using a monochrome update mode (MU) for monochrome-to-monochrome transitions, and using the greyscale update mode (GU) for greyscale-to-monochrome and monochrome-to-greyscale transitions. From top to bottom, the image 700 includes blocks with white, black, white and black regions, the image 740 includes blocks with black, white, black, and white regions, and the image 780 includes blocks with light grey, dark grey, white and black regions. Transitions between the images 700 and 740 uses MU, while transitions between images 740 and 780 use GU. When all pixels receive monochrome data, the MU mode is selected by the control 100, and when at least one pixel on the display receives greyscale data, GU mode is selected for all pixels. However, it is problematic that when the MU waveforms of FIG. 6 are used for monochrome image updates, and the GU waveforms of FIG. 5 are used for greyscale image update, an additional direct current (dc) may be introduced due to the large pulse-length difference between the MU and GU waveforms. Here, we propose to apply an additional compensating pulse prior to the application of the GU waveforms to compensate for the additional direct current (dc) when there is a change from the MU mode to the GU mode.

FIG. 8 shows a compensating pulse applied to a pixel when a display mode is changed from a monochrome to a greyscale update mode. The waveforms 800, 820, 840 and 860 illustrate waveforms in the greyscale update mode. In particular, waveform 800 indicates a transition from black (B′) to light grey (LG) using shaking pulses 805, an over-reset pulse 815, and a driving pulse 818. Waveform 820 indicates a transition from white (W′) to dark grey (DG) using shaking pulses 825, an over-reset pulse 835, and a driving pulse 838. Waveform 840 indicates a transition from black (B′) to white (W) using shaking pulses 845 and an over-reset pulse 855. Waveform 860 indicates a transition from white (W′) to black (B) using shaking pulses 865 and an over-reset pulse 875. Various other transitions are also possible, e.g., black to dark grey, and white to light grey.

Prior to applying the greyscale waveforms, a compensating voltage pulse is applied to each pixel. The compensating pulse has a duration substantially equal to the difference between the durations of the over-reset pulse of the greyscale waveform and the standard rest pulse of the monochrome waveform. Additionally, the compensating pulse has the same voltage sign or polarity as the voltage pulse used in the previous monochrome-to-monochrome image transition. For example, compensating pulses 805, 825, 845 and 865 precede the greyscale update waveforms 800, 820, 840 and 860, respectively. The compensating pulses 805 and 845 have a polarity (and magnitude) of, e.g., +15 V since the current black color state (Bₘᵤ) is obtained from a previous white-to-black transition using MU mode with a pulse of, e.g., +15V (see +15 V reset pulse 660, FIG. 6) and duration (t₁) of 400 ms. For the black (B′) to light grey (LG) transition (waveform 800), GU mode has to be selected since light grey is a greyscale color. In this case, the over-reset pulse 815 is at, e.g., −15 V with a duration (t₁+t₂) of 800 ms, and the compensating pulse 805 of, e.g., +15V is applied for a duration of (800 ms−400 ms)=400 ms prior to the start of the GU waveform 800.

Compensating pulses 825 and 865 have a polarity (and magnitude) of −15 V since the current white color state (Wₘᵤ) is obtained from the previous B-to-W transition using MU mode with a pulse of −15 V (see −15 V reset pulse 610, FIG. 6) and duration (to) of 400 ms. For the white to black transition of waveform 860, GU mode is used since it has already been selected for another pixel. The over-reset pulse 875 has a duration (t₁+t₂) of 800 ms and a polarity and magnitude of +15V. In this case, a compensating pulse 865 of −15 V for a duration of (800 ms−400 ms)=400 ms is applied prior to the start of the waveform 860. The compensating pulses 805, 825, 845 and 865 essentially compensate for additional dc voltage that would otherwise be induced at the associated pixel due to the mode change.

Note that the invention is applicable to both single and multiple window displays, where, for example, a typewriter mode exists. It must be emphasized that in the above examples, pulse-width modulated (PWM) driving is used for illustrating the invention, i.e. the pulse time is varied in each waveform while the voltage amplitude is kept constant. However, this invention is also applicable to other driving schemes, e.g., based on voltage modulated driving (VM), where the pulse voltage amplitude is varied in each waveform, or combined PWM and VM driving. When VM driving or combined VM and PWM driving is used, the compensating pulse is selected such that the energy involved in the compensating pulse is based on the energy difference between the standard reset pulse and the over-reset pulse. This invention is also applicable in color bi-stable displays, and the electrode structure is not limited such as top/bottom electrode structure or honeycomb structure or other combined in-plane-switching and vertical switching may be used.

The invention may be embodied in displays other than electronic reading devices, including inter alia, billboards or other signage.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but should be construed to cover all modifications that may fall within the scope of the appended claims.

1. A method for updating images on a bi-stable display, the method comprising:
determining when an update mode of the bi-stable display (310, 400) changes from a monochrome update mode to a greyscale update mode; and
when the update mode changes as indicated in said determining step, applying a compensating pulse (805, 825, 845, 865) to the bi-stable display, the compensating pulse representing an energy based on an energy difference between: (a) an over-reset pulse (815, 835, 855, 875) used during the greyscale update mode and (b) a standard reset pulse (610, 660) used during the monochrome update mode.

2. The method of claim 1, wherein:
applying a compensating pulse comprises applying a compensating pulse that has the same polarity as a polarity used in the standard reset pulse.

3. The method of claim 1, wherein:
applying a compensating pulse comprises applying a compensating pulse that has the same amplitude as the standard reset pulse.

4. The method of claim 1, wherein:
applying a compensating pulse comprises applying a compensating pulse wherein the pulse duration is the same as a difference between a duration of the over-reset pulse and a duration of the standard reset pulse.

5. The method of claim 1, wherein:
applying a compensating pulse comprises applying a compensating pulse to the bi-stable display prior to a greyscale update waveform (800, 820, 840 and 860) used during the greyscale update mode.

6. The method of claim 5, wherein:
the greyscale update waveform comprises shaking pulses (805, 825, 845, 865), followed by the over-reset pulse, followed by a drive pulse (818, 838).

7. The method of claim 1, further comprising:
applying a waveform to the bi-stable display during the monochrome update mode that comprises shaking pulses (605, 655), followed by the standard reset pulse.

8. The method of claim 1, wherein:
the energy of the standard reset pulse is sufficient to move particles (6) that form the bi-stable display from a black color state to a white color state, or from a white color state to a black color state.

9. The method of claim 1, wherein:
the energy of the over-reset pulse is more than sufficient to move particles (6) that form the bi-stable display from a black color state to a white color state, or from a white color state to a black color state.

10. A program storage device tangibly embodying a program of instructions executable by a machine to perform a method for updating images on a bi-stable display, the method comprising:
determining when an update mode of the bi-stable display (310, 400) changes from a monochrome update mode to a greyscale update mode; and
when the update mode changes as indicated in said determining step, applying a compensating pulse (805, 825, 845, 865) to the bi-stable display, the compensating pulse representing an energy based on an energy difference between: (a) an over-reset pulse (815, 835, 855, 875) used during the greyscale update mode and (b) a standard reset pulse (610, 660) used during the monochrome update mode.

11. A display device, comprising:
a bi-stable display (310, 400); and
a control (100) for updating images on the bi-stable display by determining when an update mode of the bi-stable display changes from a monochrome update mode to a greyscale update mode, and when the update mode changes, applying a compensating pulse (805, 825, 845, 865) to the bi-stable display, the compensating pulse representing an energy based on an energy difference between: (a) an over-reset pulse (815, 835, 855, 875) used during the greyscale update mode and (b) a standard reset pulse (610, 660) used during the monochrome update mode.

12. The display device of claim 11, wherein:
the bi-stable display comprises an electrophoretic display.

13. The display device of claim 11, wherein:
the display device comprises an electronic reading device.

14. The display device of claim 11, wherein:
the display device comprises a sign.

15. A method for updating images on a display device, the method comprising:
applying a greyscale update waveform (800, 820, 840 and 860) to the bi-stable display (310, 400) during a greyscale update mode; and
applying a monochrome update waveform (600, 650) to the bi-stable display during a monochrome update mode; wherein:
the monochrome update waveform includes a standard reset pulse (610, 660) and the greyscale update waveform includes an over-reset pulse (815, 835, 855, 875).

16. The method of claim 15, wherein:
the energy of the standard reset pulse is sufficient to move particles (6) that form the bi-stable display from a black color state to a white color state, or from a white color state to a black color state.

17. The method of claim 15, wherein:
an energy of the over-reset pulse is more than sufficient to move particles (6) that form the bi-stable display from a black color state to a white color state, or from a white color state to a black color state.

18. The method of claim 15, wherein:
an energy of the over-reset pulse is substantially greater than an energy of the standard reset pulse.

19. A program storage device tangibly embodying a program of instructions executable by a machine to perform a method for updating images on a bi-stable display, the method comprising:
applying a greyscale update waveform to the bi-stable display during a greyscale update mode; and
applying a monochrome update waveform (600, 650) to the bi-stable display during a monochrome update mode; wherein:
the monochrome update waveform includes a standard reset pulse and the greyscale update waveform includes an over-reset pulse.

20. A display device, comprising:
a bi-stable display (310, 400); and
a control (100) for updating images on the bi-stable display by applying a greyscale update waveform (800, 820, 840 and 860) to the bi-stable display during a greyscale update mode, and applying a monochrome update waveform to the bi-stable display during a monochrome update mode; wherein:
the monochrome update waveform includes a standard reset pulse (610, 660) and the greyscale update waveform includes an over-reset pulse (815, 835, 855, 875).

21. The display device of claim 20, wherein:
the bi-stable display comprises an electrophoretic display.

22. The display device of claim 20, wherein:
the bi-stable display comprises an electronic reading device.

23. The display device of claim 20, wherein:
the bi-stable display comprises a sign.
